(19) United States
(12) Patent Application Publication
(10) Pub. No.: US 2019/0009287 A1
(43) Pub. Date: Jan. 10, 2019

(54) COATING DEVICE FOR APPLYING COATING MATERIAL IN AN ELECTROSTATICALLY GUIDED MANNER, AND CORRESPONDING METHOD

(71) Applicant: EISENMANN SE, Böblingen (DE)

(72) Inventors: Jan REICHLER, Konstanz (DE); Marcus BECK, Aidlingen (DE)

(21) Appl. No.: 16/064,040

(22) PCT Filed: Dec. 8, 2016
(86) PCT No.: PCT/EP2016/080313

§ 371 Date: Jun. 20, 2018

(30) Foreign Application Priority Data
Dec. 21, 2015 (DE) 10 2015 016 448.1

(51) Int. Cl. B05B 5/16; B05B 12/14

(52) U.S. Cl. CPC B05B 5/1633; B05B 12/1463; B05B 12/149; B05B 5/1675

(57) ABSTRACT

A coating device for applying coating material onto an object in an electrostatically guided manner, and a method of providing coating material for the same, the coating device having an application device for dispensing coating material, a storage container for coating material, a coating material supply line which is connected to the storage container for supplying coating material to the storage container, and a coating line which connects the storage container to the application device. The application device and the coating line are designed to be under high voltage during a coating process. The coating device has a rinsing container for a rinsing liquid, a rinsing liquid supply line connected to the rinsing container for supplying rinsing liquid to the rinsing container, and a rinsing line which connects the rinsing container to the application device. The rinsing container and the rinsing line are designed to be under high voltage during a coating process.

### BACKGROUND OF THE INVENTION

### 1. Field of the Invention

The invention relates to a coating device for the electrostatically conducted application of coating material to an object, having

a) an application device for dispensing coating material,

b) a pre-storage vessel for coating material,

c) a coating material feed line, connected to the pre-storage vessel, for feeding coating material to the pre-storage vessel,

d) a coating line which connects the pre-storage vessel to the application device,

e) wherein the application device and the coating line are under high voltage during a coating process.

### 2. Description of the Prior Art

Such application devices are used in coating systems in order to coat for example objects in the automobile industry, such as vehicle bodies or body parts. During such a coating process, the coating material, e.g. a lacquer, is dispensed from the application device and subjected to an electric field in which the dispensed coating material is ionized and transported to the object due to electrostatic forces. The object is at earth potential, for example, for this purpose.

In the case of such of coating device, it can be a high-rotation atomizer, for example, in which the application device comprises a rotating bell-shaped disk, also called a bell, from which extremely small coating material particles, for example, lacquer droplets, are centrifuged. This effects an extremely fine distribution of the coating material, for example as a lacquer mist. In the case of the electrostatic application described here, both an external charging, in which the coating material is charged via an external electric field after leaving the application device, and a direct charging is to be understood, in which the coating material has already been charged prior to leaving the application device.

In electrostatically operating systems, material lines, which lead to components which are under high voltage during the coating process, have to be electrically isolated during a coating process. In order to construct such an isolating distance, the lines are cleaned and dried for this at least over a sufficiently long section. The lines themselves are produced from an electrically isolating material for this.

After completion of a coating process, coating material, which was not applied to the object, always remains for example in the coating line or in the application device. With regard to environmentally friendly techniques and with regard to material consumption, the aim is to recuperate as much of this material as possible. To this end, the remaining material can be pushed from the lines for example back into the respective source. For this, inter alia, use is made of the so-called pigging technology in which material is transported through the lines with the aid of a pig which works as a pushing body.

If for coating the object the coating material is to be changed, for example because lacquering is to be carried out with another color, a part of the lines, for example the coating line, also has to be cleaned.

For such a cleaning process, use is customarily made of a flushing liquid which is conducted through the corresponding lines to be cleaned, and the coating material, which remains in the lines, is carried along with it. The problem in this case is that during such a flushing process the lines which are wetted with the flushing liquid must not be under high voltage since the flushing liquid is normally electrically conductive. The interruption of the high voltage constitutes not only a time loss but also an additional material load and increased energy expenditure in addition to the safety precautions which are associated with the high voltage.

It is an object of the invention to disclose a coating device of the type referred to in the introduction, in which the flushing process can be carried out more quickly, more efficiently and/or more safely.

### SUMMARY OF THE INVENTION

This object is achieved by means of a coating device according to the independent claim 1.

The coating device according to the invention for the electrostatically conducted application of coating material to an object has an application device for dispensing coating material, a pre-storage vessel for coating material, a material feed line, connected to the pre-storage vessel, for feeding coating material to the pre-storage vessel and a coating line which connects the pre-storage vessel to the application device.

The pre-storage vessel is designed so that it can receive a defined volume of coating material per object to be coated or per coating process. The pre-storage vessel can for example be designed as a dosing unit such as a piston doser or a gear pump. It can also be a suitably formed line section.

The application device and the coating line are under high voltage during a coating process. Furthermore, the coating device has a flushing tank for a flushing liquid, a flushing liquid feed line, connected to the flushing tank, for feeding flushing liquid to the flushing tank, and a flushing line which connects the flushing tank to the application device. The flushing tank and the flushing line are designed for the purpose of being under high voltage during a coating process.

According to the invention, it is therefore possible to carry out a flushing process by means of the flushing liquid, present in the flushing tank, and the flushing line while for example the application device and the coating device are under high voltage. The flushing line and the flushing tank can therefore be kept under high voltage for example during a flushing process. A galvanic separation, that is to say the construction of an isolating distance for example by means of a time-consuming drying of a flushing line for isolating the parts of the coating device under high voltage, such as the application device and the coating line, can be dispensed with. This enables a saving of process time and flushing liquid.

Further embodiments of the invention are disclosed in the dependent claims.

One embodiment provides that the pre-storage vessel, the coating material feed line, the coating line, the flushing tank, the flushing liquid feed line and/or the flushing line are provided in multiples in order to enable an application of different coating materials. If an object is to be coated with a different coating material, for example with a different color to the previously coated object, a change of the coating material in the coating device has to be carried out. So that such a coating material change can be carried out as quickly as possible and without time loss, the coating device comprises for example two supply branches with the stated elements in each case so that a change operation is possible. For example, the application device can be fed with a first coating material from one supply branch, whereas the other supply branch is set up using another coating material.

In one embodiment, it can be provided that the application device is a high-rotation atomizer.

In one design of the invention, it can be provided that the coating device is mounted on a coating robot, especially on a multi-axis robot. In particular, the application device can be arranged on a so-called wrist of a coating robot.

In this context, it can be advantageously provided that the flushing tank is arranged near to components of the coating device which are under high voltage. Using the term “near to” is to say that the flushing tank is located in local proximity to these components, for example to the application device. In the case of the stated embodiment, in which the coating device is mounted on a coating robot, the flushing tank can for example also be arranged on the coating robot in the proximity of the wrist and is then itself also under the high voltage of the application device.

In one embodiment, it can be provided that the flushing tank has a compressed air connection. By means of the compressed air connection, the flushing tank can be charged with compressed air, as a result of which for example flushing liquid present in the flushing tank is pushed toward the points to be cleaned.

For example, the flushing liquid can be pushed into the flushing line by means of compressed air.

Furthermore, it can be provided in one embodiment that the flushing tank and/or the flushing line can be electrically isolated. This can be achieved for example by emptying and drying the flushing liquid feed line.

The object is achieved by means of a method for providing a coating material for a coating device for the electrostatically conducted application of coating material to an object. The coating device for the method has an application device for dispensing coating material, a pre-storage vessel for coating material, a flushing tank for liquid and a flushing line which connects the flushing tank to the rotating atomizer. The method features the steps:

a) loading the pre-storage vessel with a coating material;

b) loading the flushing tank with a flushing liquid;

c) applying a high voltage to the application device; and

d) charging the flushing line with applied high voltage.

Using this method, the advantages already referred to above of a possible flushing process or of a set-up of a flushing process with applied high voltage, such as a saving of process time or flushing medium, are achieved.

In a development of the method, it is provided that the step of charging the flushing line with applied high voltage includes a flushing of the application device.

### BRIEF DESCRIPTION OF THE DRAWINGS

Exemplary embodiments of the invention are explained in more detail below with reference to the drawings. In these drawings:

FIG. 1 schematically shows a coating device which is integrated into a coating system with two supply branches; and

FIGS. 2-16 show the coating device of FIG. 1 in different stages of a coating process.

### DESCRIPTION OF PREFERRED EXEMPLARY EMBODIMENTS

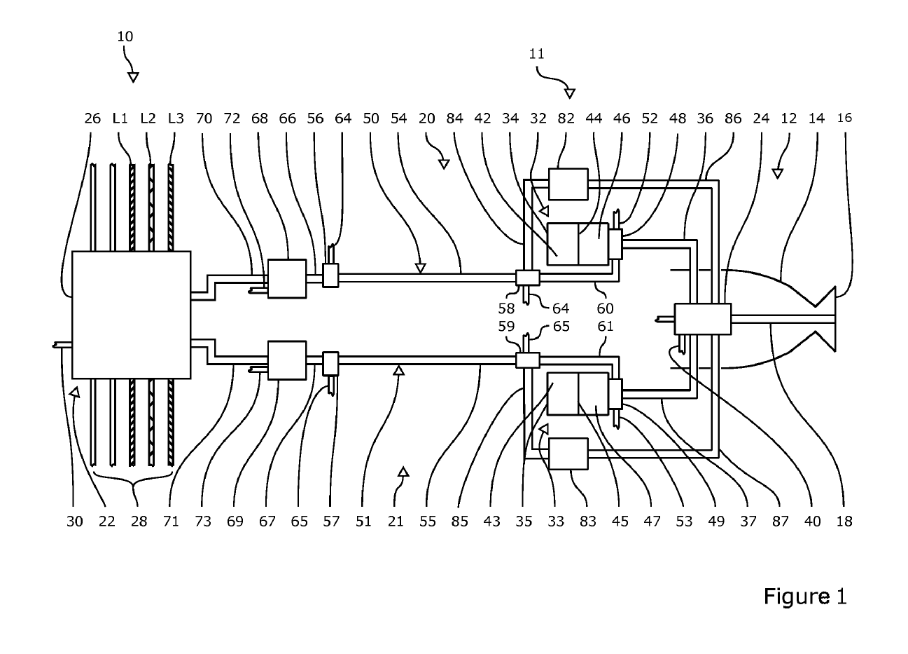

FIG. 1 schematically shows a coating system 10 for the coating of objects, such as vehicle bodies or attached components, which are not shown individually in the figures.

The coating system 10 comprises a coating device 11 with an application device 12, shown only schematically, which in the present embodiment is designed as an electrostatically operating high-rotation atomizer 14 with a rotating bell-like disk 16.

If here, or in the following text, there is talk of a connection of ports, passages or lines, a fluid connection of such components is meant by this in each case, as a result of corresponding flow paths are formed. As lines, free passages in components are also already to be understood in the present case. Therefore, a connecting line is for example already formed if two free passages of different components are fluidically interconnected.

Subsequently used terms such as intake, exit, inlet or outlet or corresponding inlet or outlet ports refer to a flow of a medium in the direction of the application device 12 or of the bell-like disk 16. Such a medium can, however, also flow in the reverse direction and in the process flow out through an intake or inlet or through an exit or outlet.

The application device 12 comprises a dispensing line 18 via which coating material can be delivered to an object. In the case of the exemplary embodiment shown in the figures, the dispensing line 18 leads to the bell-like disk 16 of the high-rotation atomizer 14. The rotating bell-like disk 16 and the dispensing line 18 therefore form a dispensing device.

The application device 12 can be selectively supplied from a first supply branch 20 or from a second supply branch 21. The first and the second supply branch 20, 21 extend in each case between an inlet valve device 22 and an outlet valve device 24.

The inlet valve device 22 is designed as a color changer 26 in the present embodiment which can be fed with different media from annular lines 28. In FIG. 1, five annular lines 28 are shown, of which three can be occupied by lacquers L1, L2 or L3. Furthermore, the inlet valve device 22 has a working line 30 via which a working fluid such as compressed air or a flushing medium is fed to the inlet valve device 22. The working line 30 can also serve as a so-called dump in order to conduct material out of the coating system 10.

For this, the working line 30 is connected to a valve device, not shown individually, which can connect the working line 30 to a compressed air source, to a flushing medium source and to an outlet. If further lines are subsequently designated as working lines, these basically fulfill the same purpose and are connected to a corresponding valve device and material sources and also to an outlet.

The first supply branch 20 and the second supply branch 21 are of the same construction in the present exemplary embodiment. The construction and the components of the first supply branch 20 are explained below. What is said for this correspondingly applies to the construction and the components of the second supply branch 21.

The first supply branch 20 comprises a first pre-storage vessel 32 in the form of a first piston doser 34 from which the application device 12 can be fed via a coating line 36. Correspondingly, the second supply branch 21 comprises a pre-storage vessel 33 in the form of a piston doser 35 from which the application device 12 can also be fed with material via a supply line 37. The piston doser 34 of the first supply branch 20 and the piston doser 35 of the second supply branch 21 illustrate an example of a pre-storage vessel for coating material in each case.

In order to connect the dispensing device 16, 18 of the application device 12 to the supply branches 20, 21, specifically to the piston dosers 34, 35 as in the present exemplary embodiment, the dispensing line 18 is connected to the outlet valve device 24. The supply lines 36, 37 open into the outlet valve device 24. The outlet valve device 24 also has a working line 40 for compressed air, flushing medium or dump.

The supply branches 20, 21, in addition to the stated components for feeding coating material, have components for feeding flushing liquid. In the supply branches 20, 21, provision is made in each case for a flushing tank 82, 83 with a flushing liquid feed line 84, 85. The flushing tanks 82, 83 are connected to the application device 12, specifically to the outlet valve device 24, in each case via a flushing line 86, 87.

The outlet valve device 24 is designed so that it can selectively connect a supply line 36, 37 to the dispensing line 18, to connect a supply line 36, 37 to a flushing line 86, 87, or to connect a flushing line 86, 87 to the dispensing line 18. Furthermore, the supply lines 36, 37 and the flushing lines 86, 87 can also be connected to the working line 40 if necessary.

If necessary, the outlet valve device 24 can be configured so that it exploits all possibilities for connecting one or more existing line(s) to one or more of the existing line(s) and can create corresponding connection variants.

The piston doser 34, 35 comprises a cylinder 42, 43 in which a piston 44, 45 can be moved by means of a piston drive, which is not shown. The piston 44, 45 together with the cylinder 43, 43 delimits a working chamber 46, 47 which is connected via a dosing valve unit 48, 49 to the supply line 36, 37. The working chamber 46, 47 is also connected via the dosing valve unit 48, 49 to an intake line 50, 51. The dosing valve unit 48, 49 is connected to a working line 52, 53 for compressed air, flushing medium or dump.

The intake line 50, 51 has a pigging line 54, 55, as a piggable line section, which extends between a first pigging station 56, 57 and a second pigging station 58, 59. In the following text, the first pigging station 56, 57 is designated as the launch pigging station and the second pigging station 58, 59 is designated as the destination pigging station.

Between the destination pigging station 58, 59 and the dosing valve unit 48, 49 provision is made for a connecting section 60, 61. Launch pigging station and destination pigging station 56, 57, 58, are connected in each case to a working line 64, 65 for compressed air, flushing medium and/or dump. The destination pigging station 58, 59 is also connected to the flushing liquid feed line 84, 85 so that for example flushing medium can be transported to the flushing tank 82, 83 via the working line 64, 65.

The launch pigging station 56, 57 is connected to a discharge connection 66, 67 of a storage vessel 68, 69. The storage vessel 68, 68 can be fed from the color changer 26 via a feed line 70, 71. The storage vessel 68, 69 is connected to a working line 72, 73 for compressed air, flushing medium and/or dump. The storage vessel 68, 69, similar to the pre-storage vessel 32, 33, can be designed as a piston doser so that coating material is transported from there by means of piston force. Alternatively, the storage vessel can also be dispensed with and the storage vessel can also be filled directly via the inlet valve device 22.

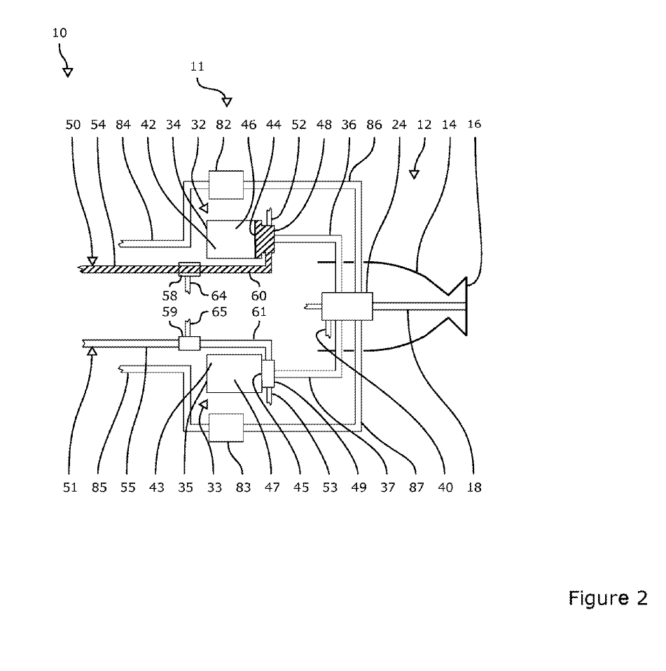

The coating system 10 is now described in operation with reference to FIGS. 2-16. FIGS. 2-16 show the relevant part of FIG. 1 in the description now following. It is assumed that for the filling of components with a medium an arrangement is made in each case for a possibly required ventilation. Also shown in FIGS. 2-16 is an alternative variant of the line run of the flushing liquid feed line 84, 85. The flushing liquid feed line does not open into the destination pigging station 58, 59 but for example can open into the inlet valve device 22.

In the initial configuration shown in FIG. 1 it is assumed that all lines and passages are cleared of material and dry. Based on this configuration, the piston doser 34 of the first supply branch 20 is first of all filled with a selected coating material. By way of example, this is a lacquer L1 from one of the annular lines 28 which in the figures is represented by hatching to the right.

From the color changer 26, a lacquer L1 I is injected via the feed line 70 into the storage vessel 68 and from there into the launch pigging station 56. A pig, not shown, is then introduced into the pigging line 54 in front of the lacquer volume and is pushed by the lacquer L1 toward the destination pigging station 58. The lacquer L1 then flows through the connecting section 60 and the dosing valve unit 48 into the piston doser 34 until this has received the desired lacquer volume to be applied. This is shown in detail in FIG. 2.

After this, the feed of lacquer from the annular line 28 is terminated and the destination pigging station 58 and the dosing valve unit 48 are connected into a configuration in which the working lines 64 and 52 are connected to the connecting section 60.

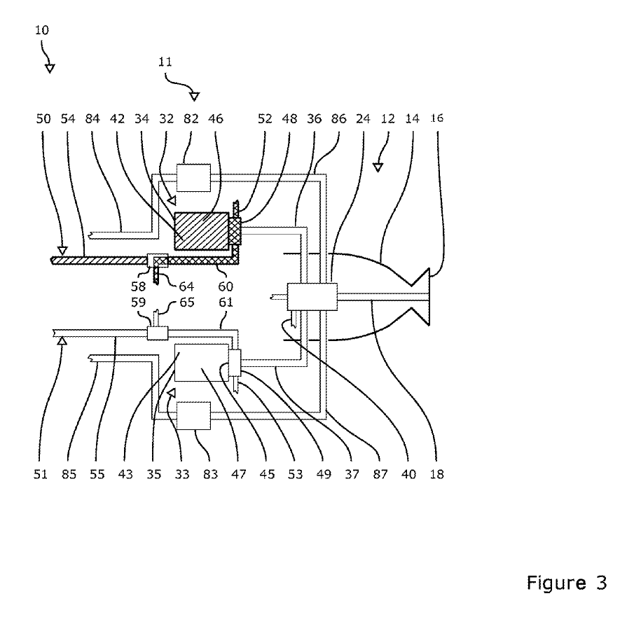

As is apparent from FIG. 3, the connecting section 60 inter alia is now flushed by flushing medium being pushed through the working line 52 of the dosing valve unit 48 toward the destination pigging station 58 and pushed out of its working line 64. The flushing medium is shown by cross-hatching in the drawings.

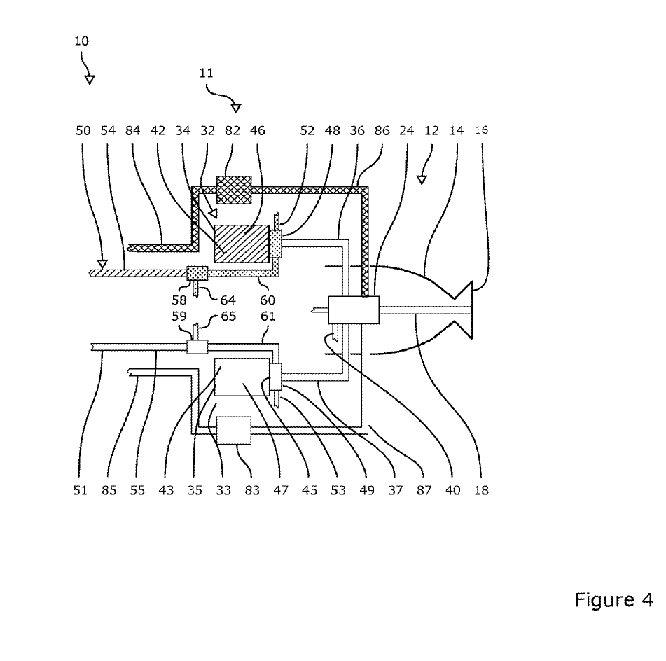

FIG. 4 shows the state in which the connecting section 60 is freed of flushing medium and blast-dried. For this purpose, for example compressed air can be blown in via the working line 52 of the dosing valve unit 48. The thereby lacquer freed and dry connecting section 60 forms an electrical insulation distance 88 between the piston doser 34 and the destination pigging station 58 and thus ensures a galvanic isolation. Electrical isolation distances are identified in the figures by a dotted pattern.

At the same time, as also shown in FIG. 4, the flushing tank 82 is filled with flushing medium. For this purpose, the flushing liquid feed line 84 and the flushing tank 82 are filled via the working line 30 of the color changer 26. At the same time, the flushing line 86 can be filled as far as the outlet valve device 24. This state is shown in FIG. 4.

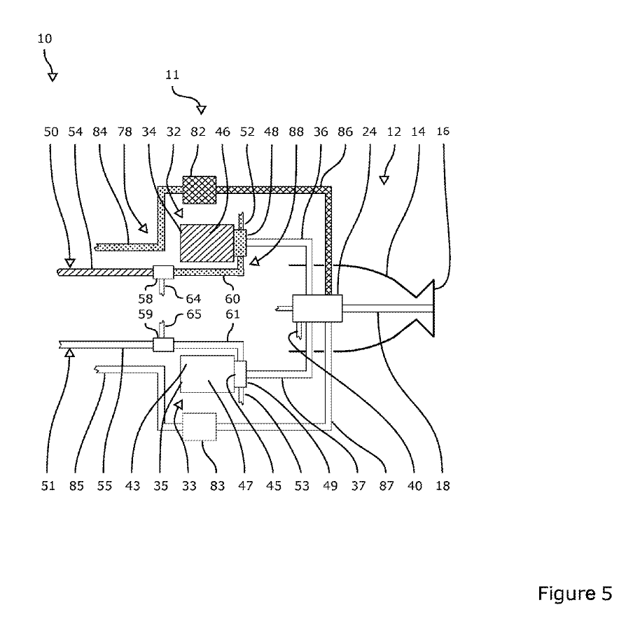

The flushing liquid feed line 84 is then dried in order to achieve an electrical isolation of the flushing tank 82 by creating an isolating distance 78. This is shown in FIG. 5: The piston doser 34 is galvanically isolated over the isolating distance 78 and the flushing tank 82 is galvanically isolated over the isolating distance 88.

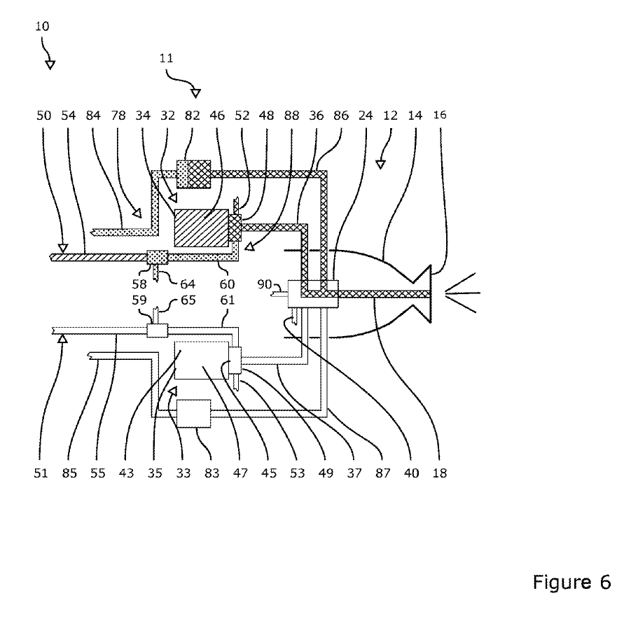

FIG. 6 now illustrates a process which would not be required in the case of the initial situation described in the introduction. If, however—prior to the initial configuration—a coating has already been carried out via the first supply branch 20, flushing of the supply line 36 via the outlet valve device 24 and the working line 52 can be carried out via the flushing tank 82 after galvanic isolation has been carried out. Alternatively or additionally, the dispensing line 18 and if necessary also the bell-like disk 16 can also be flushed with flushing medium which is made available via the flushing tank 82. Alternatively or additionally, flushing of the high-rotation atomizer 14 can be carried out via a working line 90, not previously mentioned, of the outlet valve device 24.

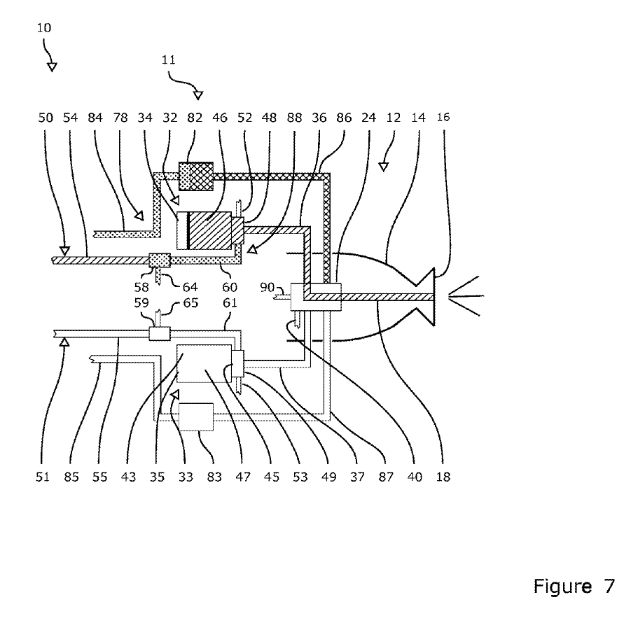

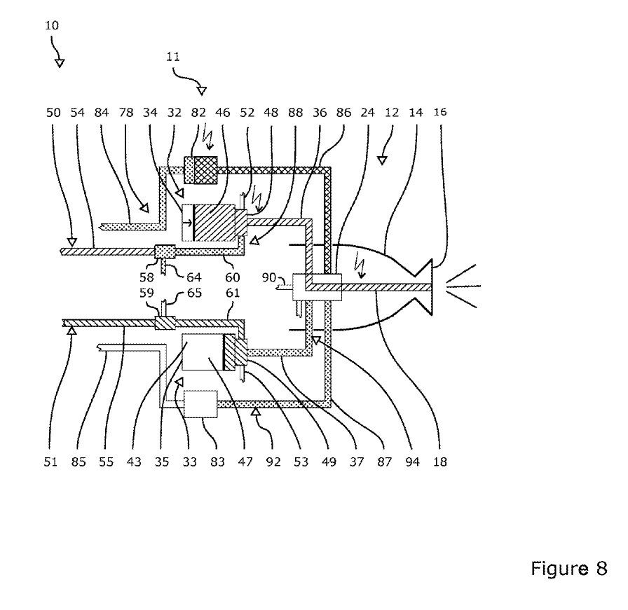

From the piston doser 34, the lacquer L1 can now be pushed via the supply line 36 toward the outlet valve device 24 and into the dispensing line 18 as far as the bell-like disk 12. In the configuration shown in FIG. 7, the coating system 10 is ready to carry out the coating process or to apply the lacquer from the application device 12 to an object, which is not shown. The high-rotation atomizer is connected to a high voltage potential. By means of the isolating distances 78, 88, a galvanic isolation in relation to the remaining region of the coating system 10 is carried out. The applying of the high voltage is shown in FIG. 8.

During the actual coating process, which is shown in FIG. 8, the high-rotation atomizer 14, the piston doser 34 and the flushing tank 82 are under high voltage. The electrically conductive lacquer in the working line 18 and also the working line 18 itself, the outlet valve device 24, the supply line 36 and the piston doser 34 also lie at the high voltage potential being applied to the high-rotation atomizer 14. The same applies to the flushing tank 82, the flushing line 86 and the outlet valve device 24.

During the application process, depending on the requirement profile of the lacquering process, for example a constant lacquer volume is transported via the piston doser 34 to the rotating bell-like disk 16. At the same time, a color change can be set up via the second supply branch 21. For this purpose, a lacquer which is different to the lacquer just applied, for example a lacquer L3—shown with hatching to the left—from the color changer 26 is pushed from one of the annular lines 28 via the feed line 71 into the storage vessel 69, and from there pushed into the launch pigging station 57 in the second supply branch 21. This can be carried out without any problem during the high voltage phase since the supply line 37 and the flushing line 87 in the second supply branch 21 form isolation distances 92 or 94, see FIG. 8 for this.

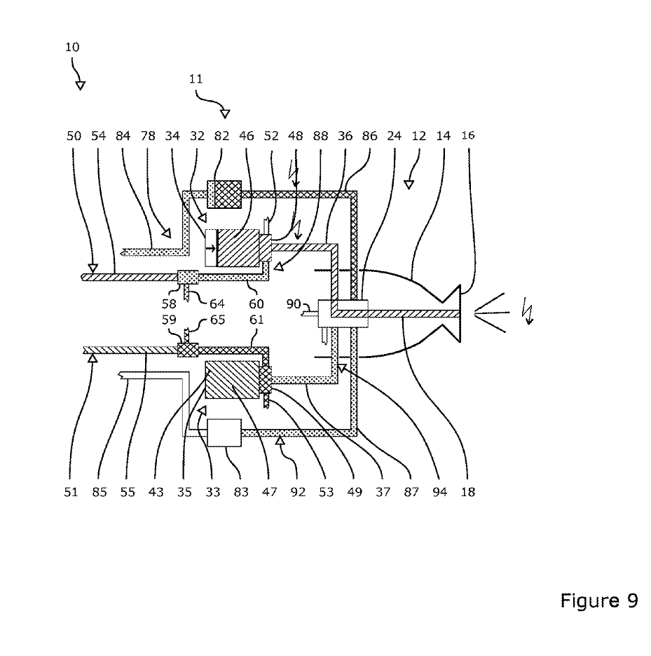

This second charging phase, which—as already explained—can be carried out during the application process and therefore under high voltage, terminates with the receiving of the lacquer volume, which is to be applied, in the piston doser 35, see FIG. 9 for this. For creating a galvanic isolation, as already described in relation to FIG. 3, the connecting section 61 is flushed by flushing medium being pushed through the working line 53 of the dosing valve unit 49 toward the destination pigging station 59 and out of its working line 65. During all these processes in the second supply branch 21, the application from the first supply branch 20 proceeds in parallel. As a result of the drying and the blowing out of the connecting section 61, an electrical isolation distance 96 is formed between the second piston doser 35 and the destination pigging station 59 in the second supply branch 21.

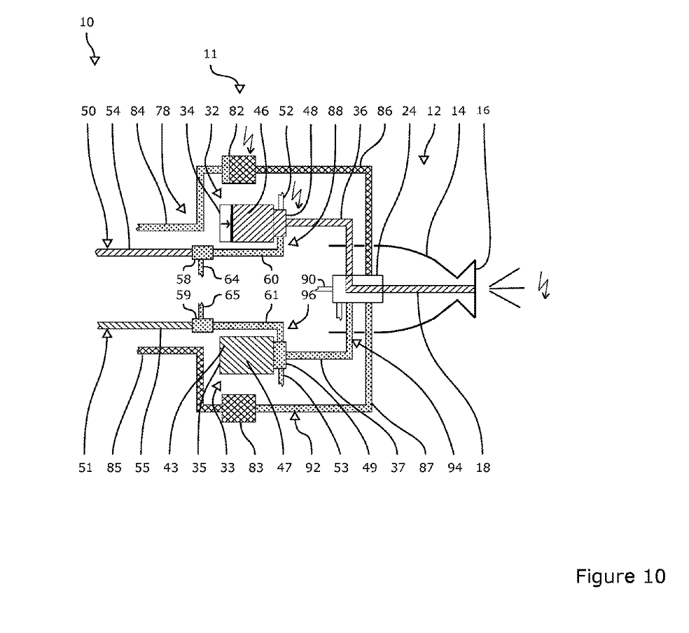

This is shown as the result in FIG. 10. At the same time, a filling of the flushing tank 83 in the second supply branch 21 can already be carried out. In contrast to FIG. 4, a filling of the flushing line 87 cannot now already be carried out since the high-rotation atomizer 14 is still under high voltage and therefore the isolation distance 92 has to be maintained.

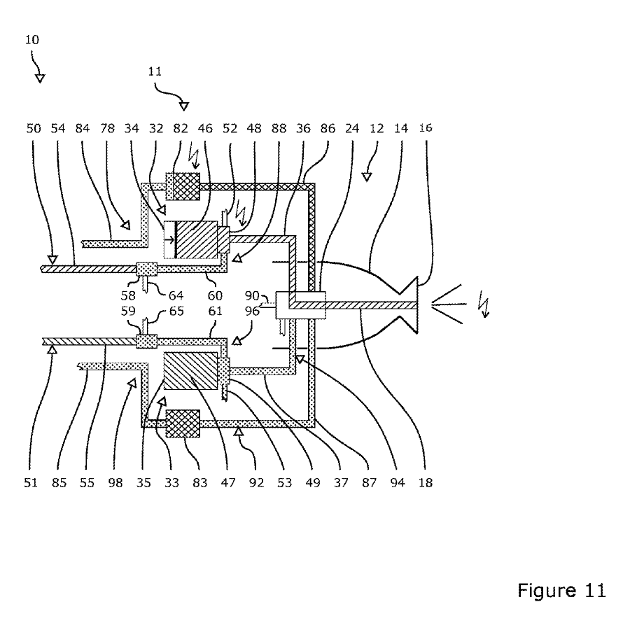

After the complete filling of the flushing tank 83 of the second supply branch 21, the flushing liquid feed line 85 is dried, as has already been described in FIG. 5 for the first supply branch 20, in order to maintain an isolation distance 98 between the flushing tank 83 of the second supply branch 21 and the rest of the coating system 10. The result is shown in FIG. 11. The flushing tank 83 and the pre-storage vessel 33 in the form of the piston doser 35 are electrically isolated both from the rest of the coating system 10 and from the application device 14 which is under high voltage.

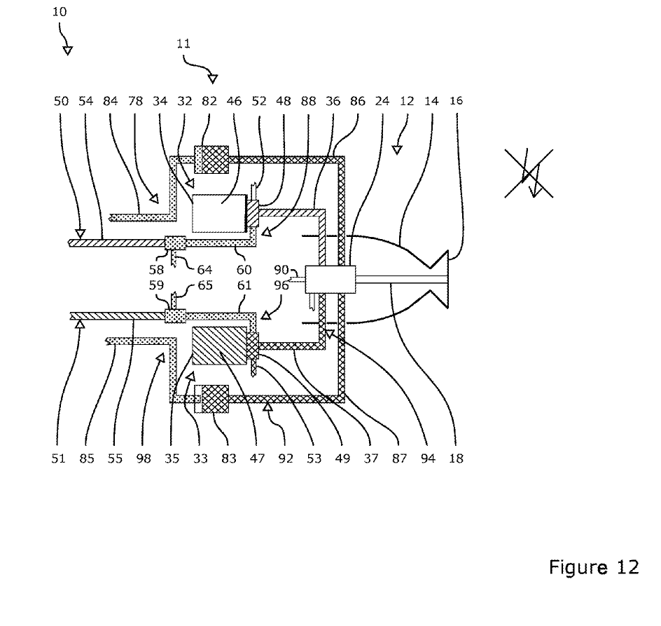

The preparations for a color change are now completely finished. The piston doser 34 of the first supply branch 20 can now be stopped. At the same time, the high voltage can be switched off. This, however, is not necessary in the case of the described embodiment. Alternatively, the high voltage can also continue to remain connected. The flushing line 87 of the second supply branch 21 can now be filled from the flushing tank 83 as far as the outlet valve device 24. Since during the previously described process dispensing of lacquer L3 via the supply line 37 is still not carried out, flushing does not have be carried out either in this case. If this should be the case, however, flushing can be carried out via the outlet valve device 24, the supply line 37 and the working line 53. This is shown in FIG. 12. If during said flushing processes high voltage should still be applied, the receiving of the remains of the flushing medium can be carried out for example in an also electrically isolated intermediate tank in which the remains of the flushing medium are collected until the high voltage is switched off.

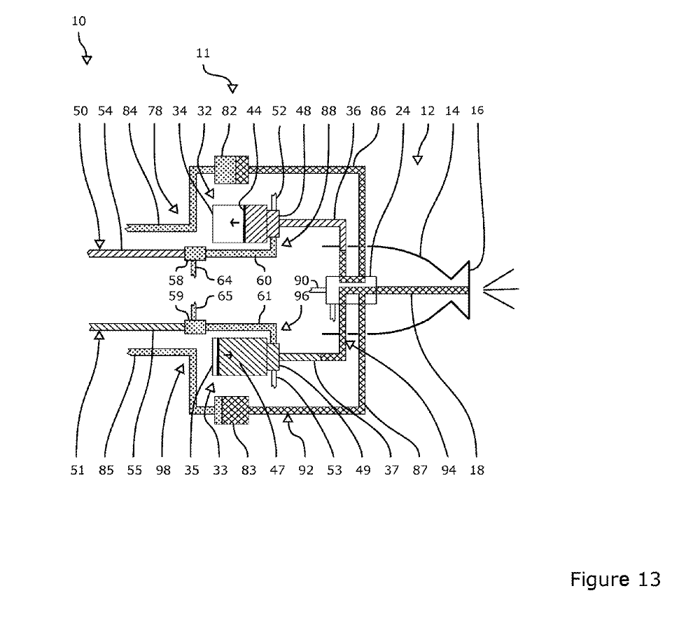

FIG. 13 shows how in parallel the lacquer L1 is pushed back into the piston doser 34 and at the same time flushing of the supply line 36 of the first supply branch 20 is carried out via a dispensing of flushing medium from the flushing tank 82. At the same time, the lacquer L3 is pushed forward as far as the outlet valve device 24. Also at the same time, via the first or the second flushing tank 82, 83 flushing of the rotating bell-like disk 16 can be carried out via the dispensing line 18 and the outlet valve device 24. In this case also, the high voltage can still continue to be applied providing a receiving of the remains of the flushing medium can be carried out in an also galvanically isolated vessel.

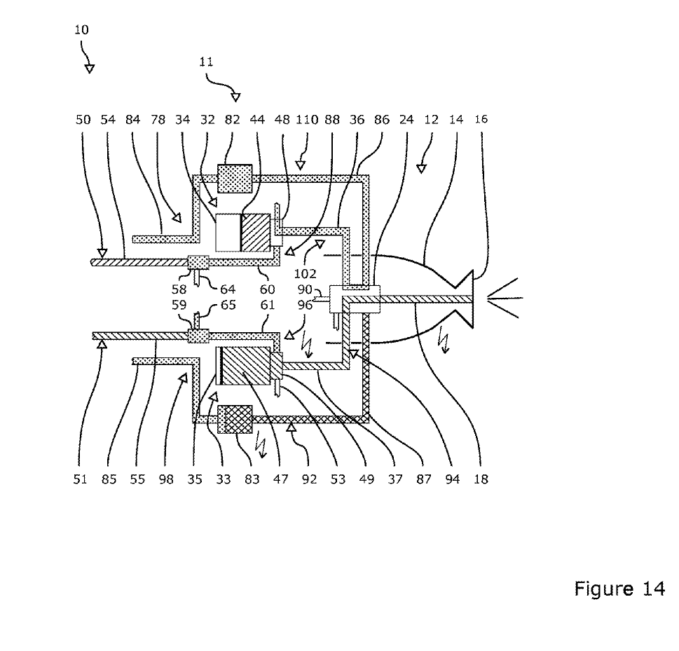

As shown in FIG. 14, the flushing line 86 and also the supply line 36 are flushed and dried by flushing medium and compressed air being pushed into the lines. Created as a result are isolation distances 110, 102 which isolate the piston conveyor 34 and the flushing tank 82 galvanically from the application device 12. After this isolation process, the high voltage can be switched on again providing it was switched off and - after a complete pushing forward of the lacquer L3 into the dispensing line 18 has been carried out in advance—the application process can be carried out using the changed lacquer L3.

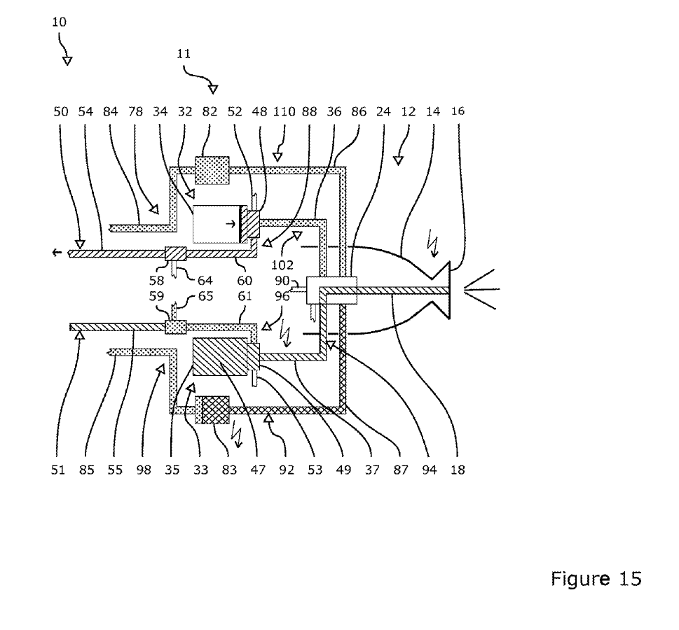

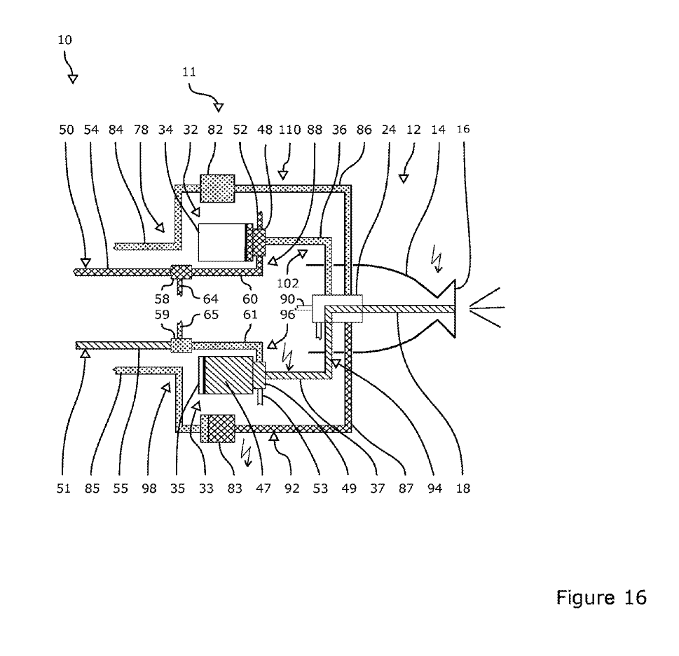

FIG. 15 shows that during the started second application process via the second supply branch 21, as shown in FIG. 15, in parallel with this the piston doser 34 and the intake line 50 in the first supply branch 20 can be cleaned and dried. For this purpose, the piston doser 34 can push back the unused lacquer L1 via the dosing valve unit 48 into the intake line 50. In this case, the lacquer in the pigging line 54 of the first supply branch 20 together with a pig from the destination pigging station 58 is pushed in the direction of the launch pigging station 56. After this, flushing medium, for example via the working line 52 and the dosing valve unit 48, can be poured into the piston doser 34 and also into the connecting section 60, if necessary also into the piggable section 54 of the intake line 50 as far as the launch pigging station 56. This is shown in FIG. 16.

What is claimed is:

1. A coating device for the electrostatically conducted application of coating material to an object, the coating device comprising:
a) an application device for the dispensing of coating material,
b) a pre-storage vessel for coating material,
c) a coating material feed line, connected to the pre-storage vessel, for feeding coating material to the pre-storage vessel,
d) a coating line which connects the pre-storage vessel to the application device,
e) wherein the application device and the coating line are designed for the purpose of being under high voltage during a coating process,
wherein the coating device includes,
f) a flushing tank for flushing liquid,
g) a flushing liquid feed line, connected to the flushing tank, for feeding flushing liquid to the flushing tank and
h) a flushing line which connects the flushing tank to the application device, wherein
i) the flushing tank and the flushing line are designed for the purpose of being under high voltage during a coating process.

2. The coating device as claimed in claim 1, wherein the pre-storage vessel, the coating material feed line, the coating line, the flushing tank, the flushing liquid feed line and/or the flushing line are provided in multiples in order to enable an application of different coating materials.

3. The coating device as claimed in claim 1, wherein the application device is a high-rotation atomizer.

4. The coating device as claimed in claim 1, wherein the coating device is mounted on a coating robot.

5. The coating device as claimed in claim 1, wherein the flushing tank is arranged near to components of the coating device which are under high voltage.

6. The coating device as claimed in claim 1, wherein the flushing tank has a compressed air connection.

7. The coating device as claimed in claim 6, wherein the flushing tank can be charged with compressed air so that flushing liquid can be pushed into the flushing line.

8. The coating device as claimed in claim 1, wherein the flushing tank and/or the flushing line can be electrically isolated.

9. A method for providing a coating material for a coating device for the electrostatically conducted application of coating material to an object, the method comprising the steps of:
a) loading a pre-storage vessel of a coating device with a coating material, wherein the coating device has an application device for dispensing coating material, the pre-storage vessel for coating material, a flushing tank for flushing liquid and a flushing line which connects the flushing tank to the rotating atomizer;
b) loading the flushing tank with a flushing liquid;
c) applying a high voltage to the application device; and
d) charging the flushing line with applied high voltage.

10. The method as claimed in claim 9, wherein the step of charging the flushing line with applied high voltage includes a flushing of the application device.

11. The coating device as claimed in in claim 1, wherein the coating device is mounted on a multi-axis robot.
